(19) United States
(12) Patent Application Publication
(10) Pub. No.: US 2021/0408958 A1
(43) Pub. Date: Dec. 30, 2021

(54) SOLAR AND ELECTROLYTIC SYSTEM COMPRISING A MOISTURE HARVESTING SOLAR SYSTEM AND AN ELECTROLYSIS CELL

(71) Applicant: Saudi Arabian Oil Company, Dhahran (SA)

(72) Inventors: Wajdi E. Sadat, Dhahran (SA); Bandar A. Fadhel, Dhahran (SA); Ahmad D. Hammad, Dhahran (SA)

(73) Assignee: Saudi Arabian Oil Company, Dhahran (SA)

(21) Appl. No.: 16/626,639

(22) PCT Filed: Nov. 27, 2019
(86) PCT No.: PCT/GR2019/000084

§ 371 Date: Dec. 26, 2019

(51) Int. Cl. H02S 10/10; H02S 40/10; H02S 10/20; C25B 1/13; C25B 15/08; C25B 9/65; C25B 1/04; C25B 13/00; C25B 9/19

(52) U.S. Cl. CPC H02S 10/10; H02S 40/10; H02S 10/20; C25B 1/13; C25B 9/19; C25B 9/65; C25B 1/04; C25B 13/00; C25B 15/08

(57) ABSTRACT

A solar and electrolytic system includes a moisture harvesting solar system that includes a photovoltaic module having a light receiving surface, a water collection subassembly, and a cleaning subassembly, The water collection subassembly has a water collection vessel and the cleaning subassembly has a water dispensing unit fluidly coupled to the water collection vessel. The solar and electrolytic system also includes an electrolysis cell with an anode and a cathode each extending into an electrolysis tank and each electrically coupled to a power supply. One or more intersystem fluid pathways fluidly couple the water collection vessel of the moisture harvesting solar system with the electrolysis tank of the electrolysis cell and one or more electrical pathways electrically couple the photovoltaic module of the moisture harvesting solar system with the power supply of the electrolysis cell.

### BACKGROUND

The present disclosure relates to a solar and electrolytic system. More specifically, the present disclosure is directed to a solar and electrolytic system that includes a moisture harvesting solar system fluidly and electrically coupled to an electrolysis cell.

### BRIEF SUMMARY

According to the subject matter of the present disclosure, a solar and electrolytic system includes a moisture harvesting solar system including a photovoltaic module having a light receiving surface exposed to ambient air, a water collection subassembly, and a cleaning subassembly. The water collection subassembly has a water collection vessel and water direction hardware positioned to direct condensed water on the light receiving surface to the water collection vessel. The cleaning subassembly has a water dispensing unit fluidly coupled to the water collection vessel via a cleaning fluid duct and positioned to dispense water from the water collection vessel over the light receiving surface. The solar and electrolytic system also includes an electrolysis cell with an anode and a cathode each extending into an electrolysis tank and each electrically coupled to a power supply. The electrolysis tank is configured to house an electrolytic solution and the power supply is configured to supply a direct current signal to the anode and the cathode to induce a electrolytic reaction of the electrolytic solution housed the electrolysis tank Further, one or more intersystem fluid pathways fluidly couple the water collection vessel of the moisture harvesting solar system with the electrolysis tank of the electrolysis cell to supply water from the water collection vessel into the electrolysis cell thereby forming at least a portion of the electrolytic solution and one or more electrical pathways electrically couple the photovoltaic module of the moisture harvesting solar system with the power supply of the electrolysis cell such that at least a portion of a photovoltaic output of the photovoltaic module is provided to the power supply of the electrolysis cell.

In accordance with an embodiment of the present disclosure, a method of supplying water and power to an electrolysis cell of a solar and electrolytic system includes generating power using a photovoltaic module of a moisture harvesting solar system, the moisture harvesting solar system having a water collection subassembly and a cleaning subassembly. The photovoltaic module includes a light receiving surface exposed to ambient air, the water collection subassembly includes a water collection vessel and water direction hardware positioned to direct condensed water on the light receiving surface to the water collection vessel, and the cleaning subassembly includes a water dispensing unit fluidly coupled to the water collection vessel via a cleaning fluid duct and positioned to dispense water from the water collection vessel over the light receiving surface. The method also includes providing water collected in the water collection vessel of the moisture harvesting solar system to an electrolysis tank of the electrolysis cell, the electrolysis cell having an anode and a cathode, each extending into the electrolysis tank and each electrically coupled to a power supply, where the electrolysis tank is fluidly coupled to the water collection vessel by one or more intersystem fluid pathways, and supplying a direct current signal from the power supply to the anode and the cathode to induce a electrolytic reaction of an electrolytic solution housed the electrolysis tank. Further, at least a portion of the electrolytic solution is water supplied from the water collection vessel and the power supply is electrically coupled to the photovoltaic module of the moisture harvesting solar system by one or more electrical pathway and at least a portion of a photovoltaic output of the photovoltaic module is provided to the power supply of the electrolysis cell.

Although the concepts of the present disclosure are described herein with primary reference to some specific solar and electrolytic system configurations, it is contemplated that the concepts will enjoy applicability to any solar and electrolytic system including a moisture harvesting solar system that is fluidly and electrically coupled to an electrolysis cell.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 schematically depicts a solar and electrolytic system comprising a moisture harvesting solar system, electrolysis cell, a deionized water production unit, and an ozone production unit, according to one or more embodiments shown and described herein;

FIG. 2A schematically depicts the moisture harvesting solar system of FIG. 1 in more detail, according to one or more embodiments shown and described herein;

FIG. 2B schematically depicts the moisture harvesting solar system of FIG. 1 in more detail with particular emphasis on the water dispensing unit and peripheral water dam thereof, according to one or more embodiments shown and described herein;

FIG. 3 schematically depicts an example configuration of the light receiving surface of the photovoltaic module, according to one or more embodiments shown and described herein;

FIG. 4 schematically depicts another example configuration of the light receiving surface of the photovoltaic module, according to one or more embodiments shown and described herein;

FIG. 5 schematically depicts the moisture harvesting solar system of FIG. 1 with particular emphasis on the ambient sensors of the system; and

FIG. 6 schematically depicts the electrolysis cell of FIG. 1 in more detail, according to one or more embodiments shown and described herein.

### DETAILED DESCRIPTION

Hydrogen based energy production relies on a source of hydrogen feedstock. Currently, fossil fuel natural gas is a common source of hydrogen feedstock, but there is a desire for hydrogen based energy production techniques that minimize the use of fossil fuels. One potential hydrogen feedstock source is water through electrolysis. However, current electrolysis techniques require intensive energy and special water characteristics to operate. Thus, improved methods and systems for producing hydrogen from electrolysis are desired. In addition, atmospheric moisture may be harvested for use a potable water, for example, in regions suffering from water scarcity and/or low quality. Interestingly, atmospheric moisture also provides a high quality water source for electrolysis because atmospheric moisture has lower a total dissolved solids level than seawater and some sources of fresh water bodies, and thus requires less treatment, less energy, and a lower cost to be used for electrolysis.

The present disclosure is directed to a solar and electrolytic system that comprises an integrated, compact and self-sustainable configuration that collectively produces water, hydrogen gas, electricity, and ozone. The solar and electrolytic system of the present disclosure is able to harvest water from atmospheric moisture that forms on a photovoltaic module (e.g., a solar panel) and use that water to produce hydrogen and oxygen via electrolysis. Further, the electrolysis is powered by solar energy harvesting from the same photovoltaic module. Indeed, the solar and electrolytic system of the present disclosure overcomes the limitation of water electrolysis deployment in arid regions and/or remote areas, facilitates direct storing of solar energy in the form of either hydrogen or water, increases the efficiency of power generation by using both of solar energy and/or hydrogen, and provides water for drinking, agricultural or industrial uses. Embodiments of the solar and electrolytic system will now be described and, whenever possible, the same reference numerals will be used throughout the drawings to refer to the same or like parts.

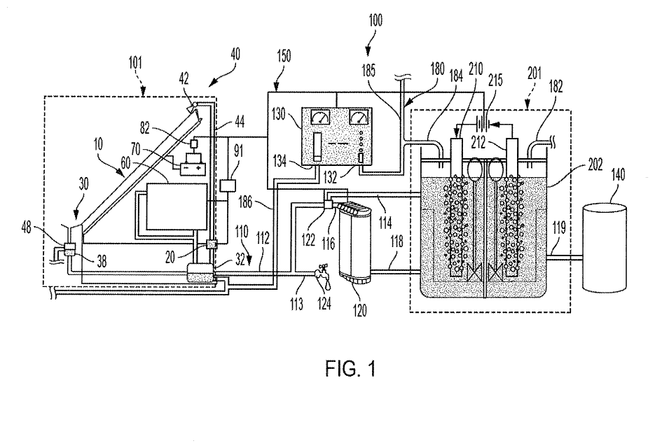

Referring now to FIG. 1, a solar and electrolytic system 100 comprising a moisture harvesting solar system 101 and an electrolysis cell 201 are schematically depicted. The moisture harvesting solar system 101 is fluidly coupled to the electrolysis cell 201 using one or more intersystem fluid pathways 110 and comprises a photovoltaic module 10 electrically coupled to the electrolysis cell 201 using one or more electrical pathways 150. In operation, the moisture harvesting solar system 101 collects water from atmospheric moisture and provides water to the electrolysis cell 201 where it may be electrolyzed and the photovoltaic module 10 of the moisture harvesting solar system 101 may harvest solar power and provide that power to the electrolysis cell 201 to facilitate the electrolysis operation.

The solar and electrolytic system 100 is an integrated system able to generate solar power and perform electrolysis and may further comprise a deionized water production unit 120, a water analyzing unit 122, and an ozone production unit 130. The deionized water production unit 120 is fluidly coupled to both the moisture harvesting solar system 101 and the electrolysis cell 201 by the one or more intersystem fluid pathways 110 and the ozone production unit 130 is fluidly coupled to both the moisture harvesting solar system 101 and the electrolysis cell 201 by one or more electrolyzed fluid pathways 180. In addition, the water analyzing unit 122 is positioned between and fluidly coupled to the moisture harvesting solar system 101 and both of the deionized water production unit 120 and the electrolysis cell 201 and, in operation, selectively directs water received from the moisture harvesting solar system 101 to either the electrolysis cell 201 or the deionized water production unit 120. Similar to the electrolysis cell 201, the deionized water production unit 120, the water analyzing unit 122, and the ozone production unit 130 may also be electrically coupled to the photovoltaic module 10 of the moisture harvesting solar system 101.

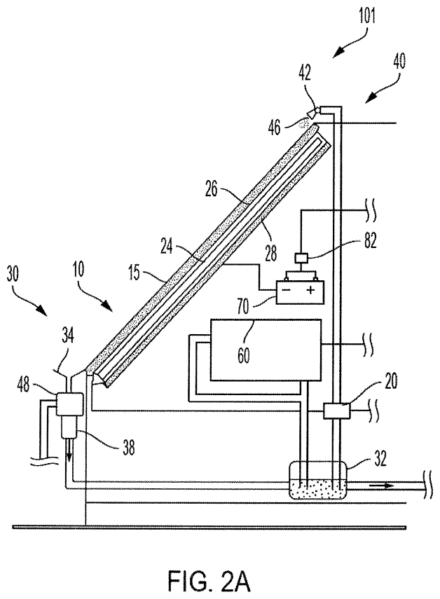

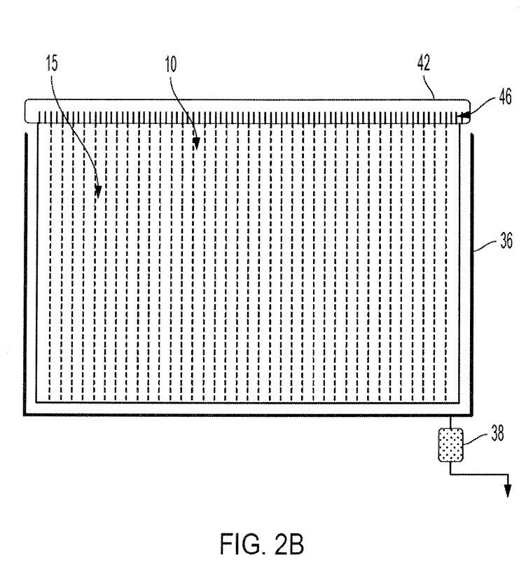

Referring also to FIG. 2A, the moisture harvesting solar system 101 is illustrated in more detail. The moisture harvesting solar system 101 comprises the photovoltaic module 10 having a light receiving surface 15 exposed to ambient air, a compressor unit 20, a water collection subassembly 30, and a cleaning subassembly 40. The light receiving surface 15 may comprise an input face of the photovoltaic module 10. The compressor unit 20 is fluidly coupled to an expansion chamber 24 and is configured to provide compressed air to the expansion chamber 24. The expansion chamber 24 is thermally coupled to the light receiving surface 15 and is thermally insulated from the ambient.

In operation, expansion of compressed air in the expansion chamber 24, as controlled by the compressor unit 20, cools the expansion chamber 24 and encourages humidity condensation on the light receiving surface 15, which is thermally coupled to the expansion chamber 24. For example, as is illustrated in FIG. 2A, the expansion chamber 24 can be thermally coupled to a backside of the photovoltaic module 10 to ensure that the light receiving surface 15 cools with the expansion chamber 24. In some embodiments, one side of the expansion chamber 24 is thermally coupled to a backside of the photovoltaic module 10 via a high thermal conductivity material 26, e.g., a conductive layer of copper or aluminum. It is also contemplated that the opposite side of the expansion chamber 24 may carry a layer of thermally insulating material 28 to minimize heat absorption directly from the environment and prevent condensation on the back side of the expansion chamber 24.

Referring still to FIG. 2A, the water collection subassembly 30 comprises a water collection vessel 32 and water direction hardware 34 that is positioned to direct condensed water on the light receiving surface to the water collection vessel 32. In addition to water direction hardware 34, which is illustrated in FIG. 2B in the form of a peripheral water dam 36 positioned along at least a portion of the periphery of the light receiving surface 15, it is contemplated that the water collection subassembly 30 may comprise a water collection filter 38 that is positioned to remove particulates from condensed water before it is directed to the water collection vessel 32. It is also contemplated that the light receiving surface 15 may be provided with a transparent hydrophobic coating to improve condensate water repellency and resulting water collection.

It is further contemplated that the compressor unit 20 may comprise a water trap positioned to dehumidify compressed air in the compressor unit 20. The water trap may be placed in fluid communication with the water collection vessel 32 of the water collection subassembly 30 via a supplemental water collection valve. In this manner, the water trap, which may comprise cooling/condensing fins, and the supplemental water collection valve can be used “on demand” to transfer captured condensate water to the water collection vessel 32. This dehumidification of the compressed air supply also prevents water entrainment on the interior surfaces of the compressor unit 20 and the expansion chamber 24 fluidly coupled thereto. The moisture harvesting solar system 101 may also include a refrigeration unit 60 fluidly coupled to the water collection vessel 32 such that water in the water collection vessel 32 may be cycled through the refrigeration unit to remove heat.

The cleaning subassembly 40 comprises a water dispensing unit 42 that is fluidly coupled to the water collection vessel 32 via a cleaning fluid duct 44. The water dispensing unit 42 may terminate in one or more water spray nozzles 46 that are directed at the light receiving surface 15 to dispense water from the water collection vessel 32 over the light receiving surface 15 of the moisture harvesting solar system 101. Cleaning fluid may be driven up the cleaning fluid duct 44 by selectively pressurizing the water collection vessel 32 via the compressor unit 20. Further, while the compressor unit 20 is schematically depicted as a single unit fluidly coupled to both the expansion chamber 24 and the water collection vessel 32, it should be understood that the compressor unit 20 may comprise multiple compressors, one fluidly coupled to the expansion chamber 24 and another fluidly coupled to the water collection vessel 32.

As depicted in FIG. 2B, the water spray nozzles 46 may be configured in a linear array of nozzles secured to a shower head pipe, each operating in range of from about 35 kPa to about 350 kPa. During surface cleaning operation, compressed air may be directed exclusively to the water collection vessel 32 to ensure adequate pressurization of the water spray nozzles 46. The cleaning subassembly 40 can additionally be provided with a water diversion valve 48 that selectively diverts wastewater from, or directs filtered wastewater to, the water collection vessel 32 for selective recycling of water during cleaning operations.

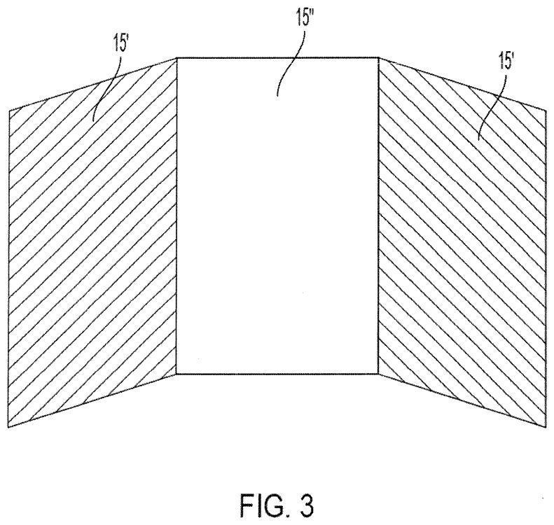

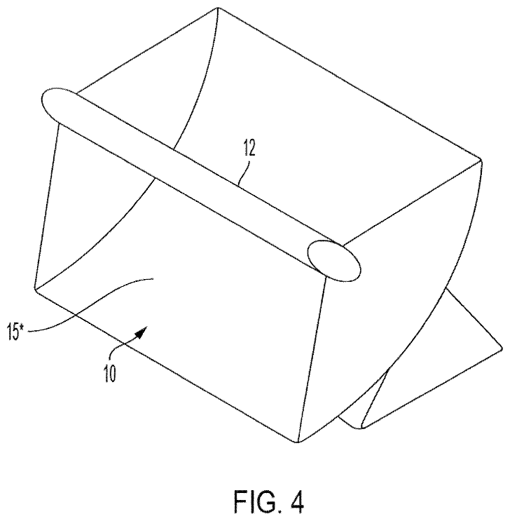

FIGS. 3 and 4 are presented to illustrate the fact that the present disclosure contemplates light receiving surfaces in a variety of forms, including substantially planar light receiving surfaces (see FIG. 2), curved light receiving surfaces 15* and complementary reflective and transmissive light receiving surfaces 15′, that are configured to direct solar energy to the transmissive light receiving surface 15″ (see FIG. 2).

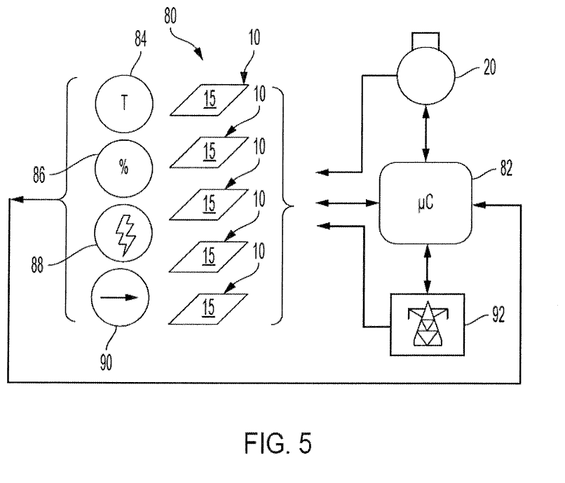

Referring now to FIG. 5, in some embodiments, the moisture harvesting solar system 101 comprises an array of solar units 80, each comprising a photovoltaic module 10 having a light receiving surface 15 and each associated with a water collection subassembly and a cleaning subassembly. In these embodiments, it is contemplated that the compressor unit 20 may comprise a central compressed air supply or a plurality of dedicated compressors in communication with individual solar units of the array of solar units 80. In either case, it is contemplated that the photovoltaic module 10 can be configured to dedicate a portion of its photovoltaic output to the compressor unit 20.

Referring to FIGS. 1, 2A, 2B, and 5, it is contemplated that the moisture harvesting solar system 101 may be provided with a process controller 82 that is programmed to ensure activation of the water dispensing unit 42 of the cleaning subassembly 40 for cleaning the light receiving surface 15 prior to activation of the water collection subassembly 30, to help avoid the entrainment of particulate matter in the collected water. The process controller 82 can also be programmed to control activation of the water collection subassembly 30 as a function of ambient temperature, humidity, or a combination thereof, in response to signals from an ambient temperature sensor 84 and an ambient humidity sensor 86. Further, to avoid activation of the compressor unit 20 when there is insufficient air pressure in the compressor unit 20, it is contemplated that the process controller 82 can be programmed to control activation of the cleaning subassembly 40 as a function of air pressure in the compressor unit 20.

The moisture harvesting solar system 101 may further comprise a photovoltaic module power monitor 88 and the process controller 82 can be programmed to control activation of the cleaning subassembly 40 as a function of power generated by the photovoltaic module 10, as sensed by the photovoltaic module power monitor 88. For example, it is contemplated that, using the aforementioned components, an automated system could be configured to measure the ambient temperature, the humidity, or system performance degradation, and determine the frequency, duration, and time-of-day for activation of the collection and cleaning subassemblies.

It is also contemplated that the process controller 82 can be programmed to control the activation conditions of the water collection subassembly 30, e.g., release duration, pressure drop, or a combination thereof, as a function of ambient sensor output by controlling the release of compressed air from the compressed air supply 50. For example, in one embodiment, the ambient sensors comprise an ambient temperature sensor 84, an ambient humidity sensor 86, an ambient wind speed sensor 90, and appropriate operating conditions of the water collection subassembly can be set by the process controller 82 in accordance with temperature, humidity, wind speed, or various combinations of other measured climate conditions.

In addition, as depicted in FIG. 1, the process controller 82 may be electrically or otherwise communicatively coupled to additional components of the solar and electrolytic system 100. In particular, the process controller 82 may be electrically coupled to each of the electrolysis cell 201, the deionized water production unit 120, the ozone production unit 130, and the water analyzing unit 122 using the one or more electrical pathways 150. In operation, the process controller 82 may provide control signals and/or direct power generated by the photovoltaic module 10 of the moisture harvesting solar system 101 to each of the electrolysis cell 201, the deionized water production unit 120, the ozone production unit 130, and the water analyzing unit 122.

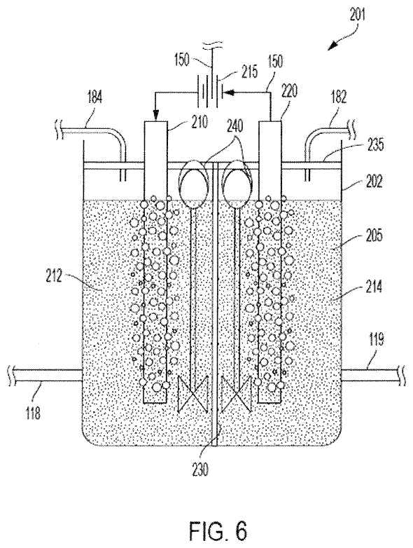

Referring now to FIG. 6, the electrolysis cell 201 is depicted in more detail. The electrolysis cell 201 comprises an anode 210 and a cathode 220 each extending into an electrolysis tank 202 and each electrically coupled to a power supply 215. The electrolysis tank 202 is configured to house an electrolytic solution 205 and the power supply 215 is configured to supply a direct current signal to the anode 210 and the cathode 220 to induce a electrolytic reaction of the electrolytic solution 205 housed the electrolysis tank 202. As shown in FIG. 6, the electrolysis cell 201 further comprises a semipermeable membrane 230 extending into the electrolysis tank 202 between the anode 210 and the cathode 220 thereby separating the electrolysis tank into an anode chamber 212 and a cathode chamber 214. Without intending to be limited by theory, during electrolysis, electricity is used to split water molecules into gaseous hydrogen at the cathode 220 and gaseous oxygen at the anode 210. While still not intending to be limited by theory, water molecules are reduced to hydrogen gas and hydroxyl ions at the cathode 220, solvated hydroxyl ions migrate through the semipermeable membrane 230 to the anode 210 where they are oxidized into oxygen gas.

In some embodiments, the electrolysis cell 201 further comprises a cap 235 coupled to the semipermeable membrane 230 enclosing both the anode chamber 212 and the cathode chamber 214. The semipermeable membrane 230 is configured to permit water and hydroxyl ion transfer between the anode chamber 212 and the cathode chamber 214 while preventing oxygen gas and hydrogen gas transfer between the anode chamber 212 and the cathode chamber. The electrolysis cell 201 may further comprise one or more agitation devices 240 extending into the electrolysis tank 202. For example, in the embodiment depicted in FIG. 6, one agitation device 240 may extend into the anode chamber 212 and another agitation device 240 may extend into the cathode chamber 214. The one or more agitation devices 240 may comprise stirring devices, vibrating devices, or any other devices configured to agitate the electrolytic solution 205 and encourage an electrolytic reaction at the anode 210 and the cathode 220.

Referring now to FIGS. 1 and 6, the one or more intersystem fluid pathways 110 fluidly couple the water collection vessel 32 of the moisture harvesting solar system 101 with the electrolysis tank 202 of the electrolysis cell 201 to supply water from the water collection vessel 32 into the electrolysis cell 201. Thus, water collected by the water collection vessel 32 may form at least a portion of the electrolytic solution 205 housed in the electrolysis tank 202. As depicted in FIG. 1, the one or more intersystem fluid pathways 110 comprise a harvested fluid duct 112 extending from the water collection vessel 32 to the water analyzing unit 122, a first analyzed fluid duct 114 extending from the water analyzing unit 122 to the electrolysis tank 202, and a second analyzed fluid duct 116 extending from the water analyzing unit 122 to the deionized water production unit 120. Further, as also depicted in FIG. 1, the one or more intersystem fluid pathways 110 include a deionized fluid duct 118 extending between the deionized water production unit 120 and the electrolysis tank 202. Thus, in the embodiment of the solar and electrolytic system 100 depicted in FIG. 1, water collected in the water collection vessel 32 may be transferred to the electrolysis tank 202 of the electrolysis cell 201 by first passing through the water analyzing unit 122 and potentially passing though the deionized water production unit 120. However, it should be understood that embodiments are contemplated in which the water collection vessel 32 is in direct fluid communication with the electrolysis tank 202 of the electrolysis cell 201. Furthermore, intersystem fluid pathways 110 may also include a direct use duct 113 fluidly coupled to the harvested fluid duct 112 and to a water output 124, such that some of the water harvested by the moisture harvesting solar system 101 may be diverted for direct use.

Referring still to FIG. 1, some embodiments also include an electrolyte storage tank 140 fluidly coupled to the electrolysis tank 202 by an electrolyte supply duct 119. The electrolyte storage tank 140 houses an electrolyte fluid, such as an alkaline electrolyte or sulfuric acid that, when supplied to the electrolysis tank 202, mixes with water from the water collection vessel 32 to form the electrolytic solution 205. In embodiments in which the electrolysis cell 201 is configured to perform alkaline water electrolysis, the electrolyte fluid may comprise an alkaline electrolyzes, such as potassium hydroxide (KOH), sodium hydroxide (NaOH), or sodium chloride (NaCl), which mixes with water in the electrolysis tank 202 to form the electrolytic solution 205. In embodiments in which the electrolysis cell 201 is configured to perform electrolysis of dilute sulfuric acid, the electrolyte fluid may comprise sulfuric acid, which mixes with water in the electrolysis tank 202 to form the electrolytic solution 205.

The water analyzing unit 122 is configured to measure the water and determine whether the water can be directly supplied to the electrolysis tank 202 for electrolysis or whether the water should first be treated by the deionized water production unit 120 before reaching the electrolysis tank 202. In particular, the water analyzing unit 122 is configured to determine a total dissolved solids (TDS) level of the water, and compare the TDS level to a threshold TDS level. For example, the water analyzing unit 122 may determine the TDS level by measuring the electrical conductivity of the water, which corresponds to the TDS level.

When the TDS level is less than the threshold TDS level, the water supplied by the water collection vessel 32 is fit to be supplied directly to the electrolysis tank 202 and used as part of the electrolytic solution 205. When the TDS level is greater than the threshold TDS level, additional treatment of the water may be performed before supplying the water to the electrolysis tank 202. In particular, when the TDS level is less than the threshold TDS level, the water is routed directly from the water analyzing unit 122 to the electrolysis tank 202 and when the TDS level is greater than the threshold TDS level, the water is routed from the water analyzing unit 122 to the deionized water production unit 120. The deionized water production unit 120 deionizes or otherwise treats the water such that the treated water comprises a TDS level that is less than the threshold TDS level. For example, the deionized water production unit 120 may remove dissolved solids from the water using an ion exchange resin, an electrodeionization process, or any other known or yet to be developed deionization technique. Thereafter, the treated water (e.g., the deionized water) is directed from the deionized water production unit 120 to the electrolysis tank 202. In some embodiments, the threshold TDS level is in a range of from 80 mg/L TDS to 120 mg/L TDS, such as 90 mg/L TDS, 100 mg/L TDS, 110 mg/L TDS, or the like.

Referring still to FIG. 1, the ozone production unit 130 is fluidly coupled to the electrolysis tank 202 of the electrolysis cell 201 by one or more electrolyzed fluid pathways 180 and is configured to receive oxygen generated by electrolysis in the electrolysis cell 201 and convert oxygen received from the electrolysis cell 201 into ozone. As shown in FIG. 1, the ozone production unit 130 includes an oxygen inlet 132 and an ozone outlet 134. The oxygen inlet. 132 fluidly coupled fluidly coupled to the electrolysis tank of the electrolysis cell by an electrolyzed oxygen duct 184, which is fluidly coupled to the anode chamber 212. For example, the electrolyzed oxygen duct 184 may extend into the cap 235 and, in some embodiment, through the cap 235 and into the anode chamber 212.

The ozone production unit 130 is configured to convert electrolyzed oxygen into ozone and output the ozone through the ozone outlet 134. For example, the ozone production unit 130 may generate an electrical discharge to split oxygen molecules into single oxygen atoms. These oxygen atoms then attached with the dioxygen (O₂) molecules received from the electrolysis cell 201 to form ozone (O₃). As shown in FIG. 1, an ozone duct 186 fluidly couples the ozone outlet 134 with the water collection vessel 32 of the moisture harvesting solar system 101. For example, ozone that is transferred form the ozone production unit 130 to the water collection vessel 32 may be used for water purification, such as pathogen removal, of the water in the water collection vessel 32 and some of this purified water may be transferred to the water output 124 for direct use. In addition, some or all of the ozone produced may be collected in one or more collection chambers or other storage devices. Collected ozone may be used for a variety of purposes, for example, to purify drinking water.

Referring still to FIG. 1, the one or more electrolyzed fluid pathways 180 also include an electrolyzed hydrogen duct 182 fluidly coupled to the cathode chamber 214. For example, the electrolyzed hydrogen duct 182 may extend into the cap 235 and, in some embodiment, through the cap 235 and into the cathode chamber 214. Hydrogen generated in the cathode chamber 214 during electrolysis may flow from the cathode chamber 214 into the electrolyzed hydrogen duct 182, which may be fluidly coupled to one or more collection chambers or other storage devices. The captured hydrogen may be used, for example, as hydrogen feedstock in hydrogen based energy production process or as fuel for hydrogen powered vehicles. Further, while the embodiments described herein primarily describe using the electrolysis generated oxygen to produce ozone, the one or more electrolyzed fluid pathways 180 comprise a direct oxygen output duct 185 fluidly coupled to the electrolyzed oxygen duct 184, which may be fluidly coupled to one or more collection chambers or other storage devices to capture and store the oxygen for other uses.

Referring still to FIGS. 1 and 6, the moisture harvesting solar system 101 and the electrolysis cell 201 are also electrically coupled. In particular, the one or more electrical pathways 150 electrically couple the photovoltaic module 10 of the moisture harvesting solar system 101 with the power supply 215 of the electrolysis cell 201 such that at least a portion of a photovoltaic output of the photovoltaic module 10 is provided to the power supply 215 of the electrolysis cell 201. The photovoltaic module 10 of the moisture harvesting solar system 101 may also provide power to any additional electrical components of the solar and electrolytic system 100. For example, one or more of the deionized water production unit 120, the water analyzing unit 122, and the ozone production unit 130 may be electrically coupled to the photovoltaic module 10 using the one or more electrical pathways 150 such that at least a portion of a photovoltaic output of the photovoltaic module 10 is provided to the deionized water production unit 120, the water analyzing unit 122, and/or the ozone production unit 130.

Referring again to FIGS. 1-6, a method of supplying water and power to the electrolysis cell 201 includes generating power using the photovoltaic module 10 and providing water collected in the water collection vessel 32 to the electrolysis tank 202 of the electrolysis cell 201. This water forms at least a portion of the electrolytic solution 205 housed in the electrolysis tank 202. In some embodiments, providing water collected from the water collection vessel 32 to the electrolysis tank 202 includes directing water from the water collection vessel 32 to the water analyzing unit 122, measuring the water using the water analyzing unit 122 to determine a TDS level of the water, and comparing the TDS level to a threshold TDS level. When the TDS level is less than the threshold TDS level, the method further comprises directing the water from the water analyzing unit 122 directly to the electrolysis tank 202, in particular, along the first analyzed fluid duct 114. Conversely, when the TDS level is greater than the threshold TDS level, the method further comprises directing water from the water analyzing unit to the deionized water production unit 120, for example, along the second analyzed fluid duct 116. The water may then be treated, for example, deionized, using the deionized water production unit 120 to reduce the TDS level to below the threshold TDS level. Once treated, the method includes directing deionized water from the deionized water production unit 120 to the electrolysis tank 202. In some embodiments, the method also includes supplying an electrolyte fluid from the electrolyte storage tank 140 to the electrolysis tank 202, using the electrolyte supply duct 119, such that the electrolyte fluid mixes with the water supplied from the water collection vessel 32 to form the electrolytic solution 205.

Next, the method comprises supplying at least a portion of the power generated by the photovoltaic module 10 to the power supply 215 of the electrolysis cell 201 and supplying a direct current signal from the power supply 215 to the anode 210 and the cathode 220 to induce a electrolytic reaction of the electrolytic solution 205 housed the electrolysis tank 202. During the electrolytic reaction, hydrogen and oxygen are formed. In particular, oxygen is formed in the anode chamber 212 and hydrogen is formed in the cathode chamber 214. Next, the method comprises directing oxygen formed during the electrolytic reaction of the electrolytic solution 205 from the electrolysis tank 202 to the ozone production unit 130 and producing ozone from the supplied oxygen using the ozone production unit 130. The method may also include supplying at least a portion of the power generated by the photovoltaic module to the water analyzing unit 122, the deionized water production unit 120, and the ozone production unit 130.

Referring again to FIGS. 1 and 5, the solar and electrolytic system 100 may comprise a supplemental power receptacle or other form of input that is configured to permit system operation under supplemental power from, e.g., an external power grid 92, which may be provided through electricity outlet 91. For example, when the photovoltaic output of the photovoltaic module 10 falls below a minimum operational threshold, as would occur at night or under other low light conditions, solar system operation may be supplemented by power by from the external power grid 92. In addition, the moisture harvesting solar system 101 may include a battery 70 electrically coupled to the photovoltaic module 10 and the process controller 82 and configured to store excess power produced by the photovoltaic module 10 such that the battery 70 may operate as a supplemental power receptacle.

For the purposes of describing and defining the present invention, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that recitations herein of a component of the present disclosure being “configured” or “programmed” in a particular way, to embody a particular property, or function in a particular manner, are structural recitations, as opposed to recitations of intended use. More specifically, the references herein to the manner in which a component is “programmed” or “configured” denotes an existing physical condition of the component and, as such, is to be taken as a definite recitation of the structural characteristics of the component.

It is noted that terms like “preferable,” “typical,” and “suitable” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

For the purposes of describing and defining the present invention it is noted that the terms “substantially” and “approximately” are utilized herein to represent the inherent degree of uncertainty that may be attributed to any quantitative comparison, value, measurement, or other representation. The terms “substantially” and “approximately” are also utilized herein to represent the degree by which a quantitative representation may vary from a stated reference without resulting in a change in the basic function of the subject matter at issue.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

What is claimed is:

1. A solar and electrolytic system comprising:
a moisture harvesting solar system comprising a photovoltaic module having a light receiving surface exposed to ambient air, a water collection subassembly, and a cleaning subassembly, wherein:
the water collection subassembly comprises a water collection vessel and water direction hardware positioned to direct condensed water on the light receiving surface to the water collection vessel; and
the cleaning subassembly comprises a water dispensing unit fluidly coupled to the water collection vessel via a cleaning fluid duct and positioned to dispense water from the water collection vessel over the light receiving surface;
an electrolysis cell comprising an anode and a cathode each extending into an electrolysis tank and each electrically coupled to a power supply, wherein:
the electrolysis tank is configured to house an electrolytic solution; and
the power supply is configured to supply a direct current signal to the anode and the cathode to induce a electrolytic reaction of the electrolytic solution housed the electrolysis tank;
one or more intersystem fluid pathways fluidly coupling the water collection vessel of the moisture harvesting solar system with the electrolysis tank of the electrolysis cell to supply water from the water collection vessel into the electrolysis cell thereby forming at least a portion of the electrolytic solution; and
one or more electrical pathways electrically coupling the photovoltaic module of the moisture harvesting solar system with the power supply of the electrolysis cell such that at least a portion of a photovoltaic output of the photovoltaic module is provided to the power supply of the electrolysis cell.

2. The solar and electrolytic system of claim 1, wherein the electrolysis cell further comprises a semipermeable membrane extending into the electrolysis tank between the anode and the cathode thereby separating the electrolysis tank into an anode chamber and a cathode chamber.

3. The solar and electrolytic system of claim 2, further comprising one or more electrolyzed fluid pathways comprising:
an electrolyzed oxygen duct fluidly coupled to the anode chamber; and
an electrolyzed hydrogen duct fluidly coupled to the cathode chamber.

4. The solar and electrolytic system of claim 1, wherein the electrolysis cell further comprises one or more agitation devices extending into the electrolysis tank.

5. The solar and electrolytic system of claim 1, further comprising an electrolyte storage tank fluidly coupled to the electrolysis tank by an electrolyte supply duct, wherein the electrolyte storage tank houses an electrolyte fluid that, when supplied to the electrolysis tank, mixes with water from the water collection vessel to form the electrolytic solution.

6. The solar and electrolytic system of claim 1, further comprising a deionized water production unit fluidly coupled to the electrolysis tank of the electrolysis cell and the water collection vessel of the moisture harvesting solar system.

7. The solar and electrolytic system of claim 6, further comprising a water analyzing unit fluidly coupled to the deionized water production unit, the electrolysis tank of the electrolysis cell, and the water collection vessel of the moisture harvesting solar system.

8. The solar and electrolytic system of claim 1, further comprising an ozone production unit comprising an oxygen inlet and an ozone outlet, wherein:
the oxygen inlet fluidly coupled fluidly coupled to the electrolysis tank of the electrolysis cell by an electrolyzed oxygen duct of one or more electrolyzed fluid pathways; and
the ozone production unit is configured to convert electrolyzed oxygen into ozone and output the ozone through the ozone outlet.

9. The solar and electrolytic system of claim 8, wherein the one or more electrolyzed fluid pathways comprise an ozone duct that fluidly couples the ozone outlet with the water collection vessel of the moisture harvesting solar system.

10. The solar and electrolytic system of claim 1, wherein the moisture harvesting solar system further comprises a compressor unit fluidly coupled to an expansion chamber that is thermally coupled to the light receiving surface and thermally insulated from the ambient.

11. The solar and electrolytic system of claim 10, wherein the expansion chamber is thermally coupled to a backside of the photovoltaic module.

12. The solar and electrolytic system of claim 10, wherein:
one side of the expansion chamber is thermally coupled to a backside of the photovoltaic module via a high thermal conductivity material; and
an opposite side of the expansion chamber carries a layer of thermally insulating material.

13. The solar and electrolytic system of claim 1, wherein the water collection subassembly of the moisture harvesting solar system comprises a water collection filter positioned to remove particulates from condensed water before it is directed to the water collection vessel.

14. The solar and electrolytic system of claim 1, wherein the water dispensing unit of the cleaning subassembly of the moisture harvesting solar system terminates in one or more water spray nozzles directed at the light receiving surface.

15. A method of supplying water and power to an electrolysis cell of a solar and electrolytic system, the method comprising:
generating power using a photovoltaic module of a moisture harvesting solar system, the moisture harvesting solar system further comprising a water collection subassembly and a cleaning subassembly, wherein:
the photovoltaic module comprises a light receiving surface exposed to ambient air;
the water collection subassembly comprises a water collection vessel and water direction hardware positioned to direct condensed water on the light receiving surface to the water collection vessel; and
the cleaning subassembly comprises a water dispensing unit fluidly coupled to the water collection vessel via a cleaning fluid duct and positioned to dispense water from the water collection vessel over the light receiving surface;
providing water collected in the water collection vessel of the moisture harvesting solar system to an electrolysis tank of the electrolysis cell, the electrolysis cell further comprising an anode and a cathode, each extending into the electrolysis tank and each electrically coupled to a power supply, wherein the electrolysis tank is fluidly coupled to the water collection vessel by one or more intersystem fluid pathways; and
supplying a direct current signal from the power supply to the anode and the cathode to induce a electrolytic reaction of an electrolytic solution housed the electrolysis tank, wherein:
at least a portion of the electrolytic solution comprises water supplied from the water collection vessel; and
the power supply is electrically coupled to the photovoltaic module of the moisture harvesting solar system by one or more electrical pathway and at least a portion of a photovoltaic output of the photovoltaic module is provided to the power supply of the electrolysis cell.

16. The method of claim 15, further comprising supplying at least a portion of the power generated by the photovoltaic module to the power supply of the electrolysis cell.

17. The method of claim 15, further comprising directing oxygen formed by the electrolytic reaction of the electrolytic solution in the electrolysis tank from the electrolysis tank to an ozone production unit and producing ozone from the supplied oxygen using the ozone production unit.

18. The method of claim 17, further comprising supplying at least a portion of the power generated by the photovoltaic module to the ozone production unit.

19. The method of claim 15, wherein providing water collected from the water collection vessel of the moisture harvesting solar system to the electrolysis tank further comprises:
directing water from the water collection vessel to a water analyzing unit;
measuring the water using the water analyzing unit to determine a total dissolved solids (TDS) level of the water;
comparing the TDS level to a threshold TDS level.

20. The method of claim 19, wherein:
when the TDS level is greater than the threshold TDS level, the method further comprises directing the water from the water analyzing unit directly to the electrolysis tank; and
when the TDS level is less than the threshold TDS level, the method further comprises:
directing water from the water analyzing unit to a deionized water production unit;
deionizing the water using the deionized water production unit; and
directing deionized water from the deionized water production unit to the electrolysis cell.
